(19) United States
(12) Patent Application Publication
(10) Pub. No.: US 2011/0144253 A1
(43) Pub. Date: Jun. 16, 2011

(54) Method for Making a 3D Photonic Crystal

(76) Inventors: Chih-Chieh CHAN, Taichung (TW); Chung-Chieh Chang, Taichung (TW); Jiun-Shou Chen, Taichung (TW); Shiao-Han Lin, Taichung (TW); Wen-Chi Chang, Taichung (TW); Wen-Chia Hsu, Taichung (TW)

(21) Appl. No.: 12/792,959

(22) Filed: Jun. 3, 2010

(30) Foreign Application Priority Data
Dec. 14, 2009 (TW) 098142705

(51) Int. Cl. C08K 3/34; C08K 3/22; C08K 3/08; C09K 3/00; C08K 5/541

(52) U.S. Cl. 524/265; 524/442; 524/406; 524/440; 252/182.33

(57) ABSTRACT

A method for making a 3D photonic crystal includes: (a) preparing a liquid mixture including a solvent component, a particulate material suspended in the solvent component, and a filler suspended or dissolved in the solvent component, with the proviso that, when the filler is suspended in the solvent component, the filler has an average size smaller than an average size of the particulate material; (b) allowing a 3D photonic structure to grow from the liquid mixture; and (c) removing liquid from the 3D photonic structure. The method can further include (d) removing the particulate material from the 3D photonic structure after the step (c). In this case, the particulate material and the filler are made of different materials.

### CROSS-REFERENCE TO RELATED APPLICATION

This application claims priority of Taiwanese application No. 098142705, filed on Dec. 14, 2009.

### BACKGROUND OF THE INVENTION

1. Field of the Invention

This invention relates to a method for making a 3D photonic crystal, more particularly to a method for making a colloidal-type 3D photonic crystal, and a method for making an inverse-type 3D photonic crystal.

2. Description of the Related Art

A photonic crystal has a nanostructure in which two materials with different dielectric constants or different refractive indexes are arranged periodically and regularly. When a full wavelength light enters the photonic crystal, a series of diffraction and interference would occur to form a photonic band gap. The photonic crystal exhibits a relatively high reflectivity at a specific wavelength of light. Such wavelength is called “specific reflection wavelength”.

Normally, an artificial photonic crystal is made by a colloidal self-assembling process, which can be conducted by gravity sedimentation, capillarity, centrifugation, temperature gradient, high-temperature evaporation, suspension, etc. The self-assembling process is conducted by providing a driving force to a particulate substance having colloid particles so as to gather colloid particles with a similar particle-size (i.e., the relative standard deviation for the size of the colloid particles is less than 10%) together and to form a 3D colloidal crystal structure. The 3D structure is known as a colloidal crystal or an artificial opal, and is formed by alternately arranging the colloid particles and air.

Another method for making a 3D photonic crystal is disclosed in Taiwan patent No. I278684. In this Taiwan patent, the 3D photonic crystal is formed downwards at a gas-liquid interface by controlling the temperature and the concentration of the colloid particles.

However, although the specific reflection wavelength of the traditionally-made 3D photonic crystal can be adjusted by varying the materials and sizes of the colloid particles, it is difficult to accurately control the specific reflection wavelength to fall within a particular range. Specifically, when the average size of the colloid particles (e.g., polystyrene microparticles, PS) increases by 10 nm, the specific reflection wavelength of the photonic crystal shifts about 24 nm. Accordingly, if the specific reflection wavelength is required to shift less than 10 nm, the average size of the PS microparticles should be precisely controlled, thereby resulting in an increase in cost and difficulty for making the photonic crystal.

On the other hand, it is known that the specific reflection wavelength of the photonic crystal can be controlled by adding a filler after the self-assembling process. However, in this case, the shifting of the wavelength is at most 6% and the process is hard to be controlled and time-consuming.

### SUMMARY OE THE INVENTION

Therefore, an object of the present invention is to provide a method for making a 3D photonic crystal that can overcome the aforesaid drawbacks.

Accordingly, a method for making a 3D photonic crystal of the present invention comprises:

(a) preparing a liquid mixture including a solvent component, a particulate material suspended in the solvent component, and a filler suspended or dissolved in the solvent component, with the proviso that, when the filler is suspended in the solvent component, the filler has an average size smaller than an average size of the particulate material;

(b) allowing a 3D photonic structure to grow from the liquid mixture; and

(c) removing liquid from the 3D photonic structure.

By the above method, a colloidal-type 3D photonic crystal can be manufactured.

Alternatively, the method can further comprise: (d) removing the particulate material from the 3D photonic structure after the step (c). Accordingly, an inverse-type 3D photonic crystal can be manufactured.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 shows relationship between reflectance and wavelength for the 3D photonic crystals of Comparative Examples 1 to 5;

FIG. 2 shows relationship between reflectance and wavelength for the 3D photonic crystals of Examples 1 to 4 according to the present invention and Comparative Example 4; and

FIG. 3 shows a scanning electron microscope image, at a magnification of 40000 times, of an inverse-type 3D photonic crystal of Example 40 according to the present invention.

### DETAILED DESCRIPTION OF THE PREFERRED EMBODIMENTS

In the past days, the conventional 3D photonic crystal is formed by using a particulate substance having colloid particles with a similar particle-size (i.e., the relative standard deviation for the size of the colloid particles is less than 10%), and is formed by alternately arranging the colloid particles and air. The specific reflection wavelength of the conventional 3D photonic crystal is adjusted by varying the average size of the colloid particles, or by adding a filler after a self-assembling process of the 3D photonic crystal. In this invention, the inventors found that, by using the particulate substance and the filler during the self-assembling process, the specific reflection wavelength of the 3D photonic crystal can be slightly shifted by adjusting the materials and concentration of the filler.

In the present invention, a colloidal-type 3D photonic crystal is made in the first embodiment, and an inverse-type 3D photonic crystal is made in the second embodiment.

The method for ma king the 3D photonic crystal according to the first embodiment of the present invention comprises: (a) preparing a liquid mixture including a solvent component, a particulate material suspended in the solvent component, a filler suspended or dissolved in the solvent component, with the proviso that, when the filler is suspended in the solvent component, the filler has an average size smaller than an average size of the particulate material; (b) allowing a 3D photonic structure to grow from the liquid mixture through a self-assembling process; and (c) removing liquid from the 3D photonic structure.

Preferably, the solvent component includes a first solvent for suspension of the particulate material and a second solvent for suspension or dissolution of the filler. The first and second solvents can be the same or different. Preferably, when the first and second solvents are different, the first and second solvents are mutually soluble.

The particulate material has an average size in micrometer or nanometer. Preferably, the average size of the particulate material ranges from 0.1 μm to 10 μm.

When the filler is suspended in the solvent component, the average size of the filler is smaller than 1/10 of that of the particulate material. Preferably, the average size of the suspended filler is smaller than 1/30 of that of the particulate material. More preferably, the average size of the suspended filler is smaller than 1/50 of that of the particulate material.

Preferably, the particulate material is made from a material selected from the group consisting of organic polymer, inorganic compound, metal, and combinations thereof.

Preferably, the organic polymer of the particulate material is made from a material selected from the group consisting of polymers of polystyrene series, polymethyl methacrylate series, poly(maleic acid) series, polylacetic acid series, polyamino acid series, and combinations thereof.

Preferably, examples of the inorganic compound of the particulate material include Ag₂O, CuO, ZnO, CdO, NiO, PdO, CoO, MgO, SiO₂, SnO₂, TiO₂, ZrO₂, HfO₂, ThO₂, CeO₂, CoO₂, MnO₂, IrO₂, VO₂, WO₃, MoO₃, Al₂O₃, Y₂O₃, Yb₂O₃, Dy₂O₃, B₂O₃, Cr₂O₃, Fe₂O₃, Fe₃O₄, V₂O₅, Nb₂O₅, ZnS, ZnSe, ZnTe, CdS, CdSe, CdTe, FeS, FeSe, FeTe, CoS, CoSe, CoTe, NiS, NiSe, NiTe, PbS, PbSe, PbTe, MnS, MnSe, MnTe, SnS, SnSe, SnTe, MoS₂, MoSe₂, MoTe₂, WS₂, WSe₂, WTe₂, Cu₂S, Cu₂Se, Cu₂Te, Bi₂S₃, Bi₂Se₃, Bi₂Te₃, SiC, TiC, ZrC, WC, NbC, TaC, Mo₂C, BN, AlN, TiN, ZrN, VN, NbN, TaN, Si₃N₄, Zr₃N₄, and combinations thereof.

Preferably, examples of the metal of the particulate material include Au, Ag, Cu, Fe, Co, Ni, Pd, Pt, Al, Si, Ti, Zr, V, Nb, Mo, W, and Mn, and combinations thereof.

Preferably, the filler is made of a material selected from the group consisting of an inorganic salt, inorganic oxide, metal, inorganic alkoxide, and combinations thereof.

Preferably, examples of the inorganic salt of the filler include group IIIA elements, group IVA elements, group VA elements, group VIA elements, and group VITA elements, and combinations thereof.

Preferably, examples of the inorganic oxide of the filler include Ag₂O, CuO, ZnO, CdO, NiO, PdO, CoO, MgO, SiO₂, SnO₂, TiO₂, ZrO₂, HfO₂, ThO₂, CeO₂, CoO₂, MnO₂, TrO₂, VO₂, WO₃, MoO₃, Al₂O₃, Y₂O₃, Yb₂O₃, Dy₂O₃, B₂O₃, Cr₂O₃, Fe₂O₃, Fe₃O₄, V₂O₅, Nb₂O₅, and combinations thereof.

Preferably, examples of the metal of the filler include Au, Ag, Cu, Fe, Co, Ni, Pd, Pt, Al, Si, Ti, Zr, V, Nb, Mo, W, Mn, and combinations thereof.

Preferably, examples of the inorganic alkoxide of the filler include alkoxysilane, aluminum alkoxide, titanium alkoxide, zirconium alkoxide, and combinations thereof.

The step (b) is preferably conducted by, but is not limited to, gravity sedimentation, centrifugal sedimentation, electrical sedimentation, magnetic sedimentation, vacuum filtration, pressure filtration, centrifugal filtration, or combinations thereof.

The step (c) is preferably conducted by, but is not limited to, natural drying, vacuum drying, oven drying, microwave drying, infrared drying, or combinations thereof.

In an embodiment of this invention, the 3D photonic structure is grown on a substrate.

The method for making a photonic crystal according to the second embodiment of the present invention differs from the first embodiment in that the method of the second embodiment further comprises: (d) removing the particulate material from the 3D photonic structure after the step (c) and that the particulate material and the filler are made of different materials.

In the step (d), the particulate material is removed by a calcining process or by dissolving the particulate material in a solvent.

By adjusting materials and size of the particulate material, and materials, size and the amount of the filler, a 3D photonic crystal having a specific reflection wavelength ranging from 0.2 μm to 20 μm, can be made. Preferably, the specific reflection wavelength ranges from 0.2 μm to 2 μm. Furthermore, by adding the filler during self-assembling and varying the materials and concentrations of the fillers, the specific reflection wavelength of the 3D photonic crystal of this invention can be precisely controlled without varying the average size of the particulate material, thereby resulting in more flexibility for the 3D photonic crystal made by the method of the present invention in the industrial application.

### EXAMPLES

### Equipments

1. UV-Vis Spectrophotometer, model No. BAL2000, available from Ocean Optics, Inc., USA.

2. Cold Field Emission Scanning Electron Microscope (FESEM), model No. S-4800, available from HITACHI, Japan.

### Comparative Examples 1 to 5 (C1 to C5)

3D photonic crystals of Comparative Examples 1 to 5 were respectively made by a conventional method for making a colloidal-type 3D photonic crystal.

For making the 3D photonic crystal of Comparative Example 1, a stock suspension of PS nanoparticles, serving as a particulate material, with an average size of 150 nm was diluted using deionized water (DI water) followed by an ultrasonic treatment for 30 minutes so as to prepare a PS suspension having a solid content of 30 mg/ml. Then, 17 μl of the PS suspension was dropped on a dried glass substrate (1 cm×1 cm), and the glass substrate having the PS suspension was dried at 80° C. for 15-20 minutes in an oven to obtain the 3D photonic crystal of Comparative Example 1.

The 3D photonic crystals of Comparative Examples 2 to 5 were made by the same method as Comparative Example 1, except that the PS nanoparticles in Comparative Examples 2 to 5 respectively have average sizes of 230 nm, 290 nm, 320 nm, and 340 nm.

In addition, the PS nanoparticles used in the Examples and Comparative Examples were prepared by an emulsion-free polymerization using styrene and an anion initiator of potassium persulfate.

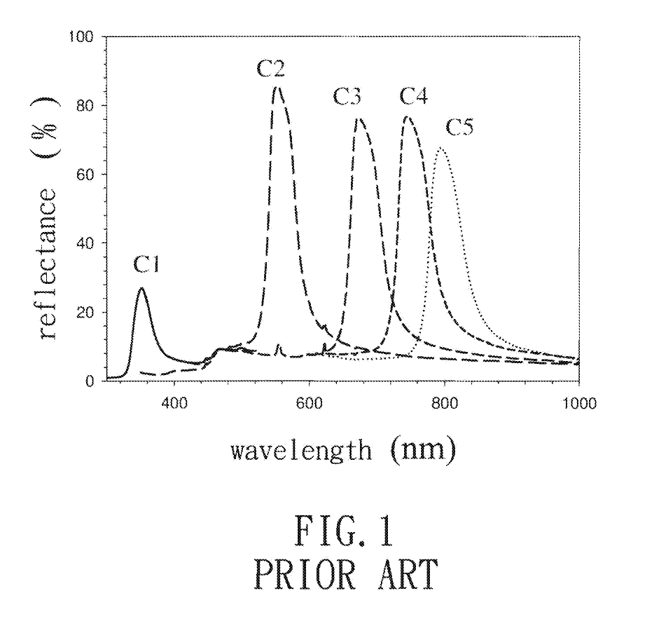

The 3D photonic crystals of Comparative Examples 1 to 5 were measured by the UV-Vis Spectrophotometer, which was operated at a scan range from 200 nm to 1100 nm, to determine the specific reflection wavelengths thereof. As shown in FIG. 1, the specific reflection wavelengths for the 3D photonic crystals of Comparative Examples 1 to 5 are 351 nm, 553 nm, 673 nm, 745 nm, and 794 nm, respectively. Note that when the particle size of the PS nanoparticles is varied slightly, the specific reflection wavelength shifts in a relatively great extent. Therefore, it is difficult to shift the specific reflection wavelength within the scale of 10 nm unless the particle size of the PS nanoparticles can be precisely controlled. However, such precise control is relatively hard to achieve and will increase the manufacturing cost.

### Comparative Examples 6 and 7 (C6 and C7)

3D photonic crystals of Comparative Examples 6 and 7 were made by the same method as Comparative Example 1, except that the PS nanoparticles in Comparative Example 6 have an average size of 190 nm, and that the nanoparticles in Comparative Example 7 are SiO₂ nanoparticles having an average size of 300 nm. The SiO₂ nanoparticles in Comparative Example 7 and the following Examples were prepared by a Stöber method using tetraethoxysilane (TEOS).

The specific reflection wavelengths for the 3D photonic crystals of Comparative Examples 6 and 7, which were measured using the UV-Vis Spectrophotometer operated as that in Comparative Example 1, are 446 nm and 695 nm, respectively (see Table 1).

### Examples 1 to 27 (E1 to E27)

The 3D photonic crystal of Example 1 was made by the method according to the first embodiment of the present invention as follows:

(a) A stock PS suspension having PS nanoparticles with an average size of 320 nm, as a particulate material, was added in DI water (the first solvent) so as to formulate a particulate material suspension having a solid content of 30 mg/ml. Then, the particulate material suspension was treated by an ultrasonic treatment for 30 minutes to well suspend PS nanoparticles therein.

(b) 1 ml of the particulate material suspension was mixed with 1 ml of a filler solution (0.01 M, obtained by dissolving Na₂O₇Si₃ as a filler in DI water as a second solvent), followed by ultrasonic treatment for 5 minutes so as to obtain a liquid mixture.

(c) 17 μl of the liquid mixture was dropped on a dried glass substrate (1 cm×1 cm), and then, the substrate was dried at 80° C. for 15˜20 minutes in an oven so as to form a colloidal-type 3D photonic crystal.

The 3D photonic crystals of Examples 2 to 27 were made by the same method as Example 1, except that the species and particle size of the particulate material and the species and concentration of the filler and the second solvent used to dissolve or suspend the fillers in each example are different from those of Example 1. The relevant information with respect to the particulate material, the filler, and the specific reflection wavelengths for Examples 1 to 27 are shown in Table 1.

TABLE 1

| | | | | | Filler solution or | | | |
|---|---|---|---|---|---|---|---|---|
| | Particulate material suspension | | | | Filler suspension | | | |
| | Particulate | Size | Conc. | 1^{st} | | Conc. (M) or | 2^{nd} | Wavelength |
| | material | (nm) | (mg/ml) | solv. | Filler | (mg/ml) | solv. | (nm) |
| C4 | PS | 320 | 30 | H₂O | — | — | — | 745 |
| E1 | PS | 320 | 30 | H₂O | Na₂O₇Si₃ | 0.01 | H₂O | 763 |
| E2 | PS | 320 | 30 | H₂O | Na₂O₇Si₃ | 0.02 | H₂O | 769 |
| E3 | PS | 320 | 30 | H₂O | Na₂O₇Si₃ | 0.04 | H₂O | 779 |
| E4 | PS | 320 | 30 | H₂O | Na₂O₇Si₃ | 0.08 | H₂O | 803 |
| E5 | PS | 320 | 30 | H₂O | Na₂WO₄ | 0.00375 | H₂O | 759 |
| E6 | PS | 320 | 30 | H₂O | Na₂WO₄ | 0.0075 | H₂O | 762 |
| E7 | PS | 320 | 30 | H₂O | Na₂WO₄ | 0.015 | H₂O | 777 |
| E8 | PS | 320 | 30 | H₂O | Na₂WO₄ | 0.03 | H₂O | 791 |
| E9 | PS | 320 | 30 | H₂O | V₂O₅ | 0.00125 | 20% | 769 |
| | | | | | | | H₂O₂ | |
| E10 | PS | 320 | 30 | H₂O | V₂O₅ | 0.0025 | 20% | 778 |
| | | | | | | | H₂O₂ | |
| E11 | PS | 320 | 30 | H₂O | V₂O₅ | 0.005 | 20% | 788 |
| | | | | | | | H₂O₂ | |
| E12 | PS | 320 | 30 | H₂O | V₂O₅ | 0.01 | 20% | 798 |
| | | | | | | | H₂O₂ | |
| C2 | PS | 230 | 30 | H₂O | — | — | — | 553 |
| E13 | PS | 230 | 30 | H₂O | TEOS | 0.225 | H₂O | 555 |
| E14 | PS | 230 | 30 | H₂O | TEOS | 0.45 | H₂O | 558 |
| E15 | PS | 230 | 30 | H₂O | TEOS | 0.9 | H₂O | 565 |
| E16 | PS | 230 | 30 | H₂O | TEOS | 1.8 | H₂O | 575 |
| E17 | PS | 230 | 30 | H₂O | Au | 0.5 | H₂O | 555 |
| E18 | PS | 230 | 30 | H₂O | Au | 1.0 | H₂O | 559 |
| E19 | PS | 230 | 30 | H₂O | Au | 2.0 | H₂O | 568 |
| E20 | PS | 230 | 30 | H₂O | Au | 4.0 | H₂O | 571 |
| E21 | PS | 230 | 30 | H₂O | Au | 6.0 | H₂O | 581 |
| C6 | PS | 190 | 30 | H₂O | — | — | — | 446 |
| E22 | PS | 190 | 30 | H₂O | Au | 2.0 | H₂O | 451 |
| E23 | PS | 190 | 30 | H₂O | Au | 4.0 | H₂O | 459 |
| E24 | PS | 190 | 30 | H₂O | Au | 6.0 | H₂O | 464 |
| C7 | SiO₂ | 300 | 30 | H₂O | — | — | — | 695 |
| E25 | SiO₂ | 300 | 30 | H₂O | Au | 2.0 | H₂O | 699 |
| E26 | SiO₂ | 300 | 30 | H₂O | Au | 4.0 | H₂O | 704 |
| E27 | SiO₂ | 300 | 30 | H₂O | Au | 6.0 | H₂O | 715 |

“—” means not added.
The concentrations of the particulate material in the Examples and Comparative Examples are represented by solid content (mg/ml).
The fillers in Examples 1 to 16 are dissolved in the second solvent, and the concentrations of the fillers are represented by molar concentration (M).
The fillers in Examples 17 to 27 are suspended in the second solvent, and have particle sizes ranging from 3 nm to 5 nm. The concentrations of the fillers in Examples 17 to 27 are represented by solid content (mg/ml) since Au is suspended in DI water.
H₂O means DI water.
Wavelength means the specific reflection wavelength.

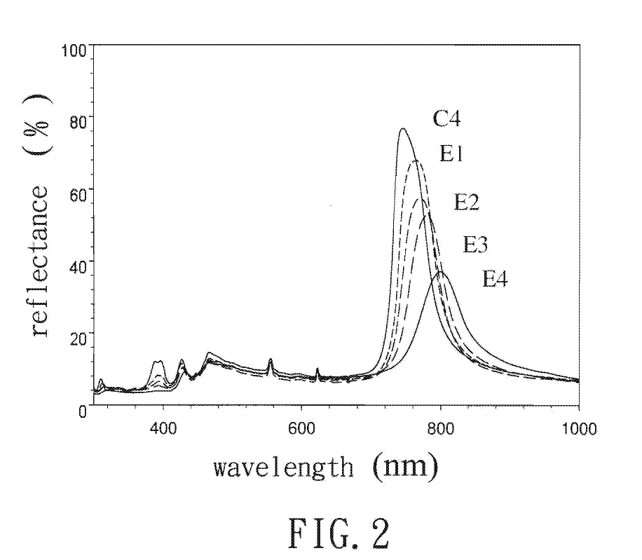

According to the results shown in Table 1, the specific reflection wavelength of the 3D photonic crystal can be slightly shifted by adjusting the concentration or solid content of the filler. In FIG. 2, which shows relationship between reflectance and wavelength among the 3D photonic crystals of the Examples 1 to 4 (E1 to E4) according to the present invention and the comparative example 4 (C4), the specific reflection wavelength of the 3D photonic crystal is slightly shifted by changing the concentration of the filler (Na₂O₇Si₃ solution). The adjustment of the concentration of the filler is much easier than control of the particle size of the particulate material used in the prior art.

### Examples 28 to 39 (E28 to E29)

The method for making a 3D photonic crystal of Example 28 (i.e., the method according to the second embodiment of the present invention) is similar to that of Example 1, but further comprises a calcining process to remove the particulate material embedded therein. Specifically, the calcining process was conducted by increasing the temperature in a furnace at a rate of 10° C./min to 400° C., followed by heat treatment of the colloidal-type 3D photonic crystal for 1 hour to remove the particulate material, thereby forming an inverse-type 3D photonic crystal.

The 3D photonic crystals of Examples 29 to 39 were made by the same method as Example 28, except that the filler in each of the Examples is different from that of Example 28. The species and concentration of the filler, the second solvent used to dissolve the filler, and the specific reflection wavelengths thus measured are shown in Table 2.

TABLE 2

| | | | | Specific |
|---|---|---|---|---|
| | Filler solution | | | reflection |
| | | Conc. | 2^{nd} | wavelength |
| | Filler | (M) | solvent | (nm) |
| E28 | Na₂O₇Si₃ | 0.01 | H₂O | 524 |
| E29 | Na₂O₇Si₃ | 0.02 | H₂O | 537 |
| E30 | Na₂O₇Si₃ | 0.04 | H₂O | 556 |
| E31 | Na₂O₇Si₃ | 0.08 | H₂O | 579 |
| E32 | Na₂WO₄ | 0.00375 | H₂O | 623 |
| E33 | Na₂WO₄ | 0.0075 | H₂O | 642 |
| E34 | Na₂WO₄ | 0.015 | H₂O | 661 |
| E35 | Na₂WO₄ | 0.03 | H₂O | 678 |
| E36 | V₂O₅ | 0.00125 | 20% H₂O₂ | 630 |
| E37 | V₂O₅ | 0.0025 | 20% H₂O₂ | 669 |
| E38 | V₂O₅ | 0.005 | 20% H₂O₂ | 674 |
| E39 | V₂O₅ | 0.01 | 20% H₂O₂ | 682 |

As shown in Table 2, the specific reflection wavelength of the 3D photonic crystal can also be slightly shifted by adjusting the concentration of the filler. The adjustment of the concentration of the filler is much easier than control of the particle size of the particulate material.

### Example 40

The inverse-type 3D photonic crystal of Example 40 was made by the same method as Example 28, except that the average size of the particulate material is 290 nm.

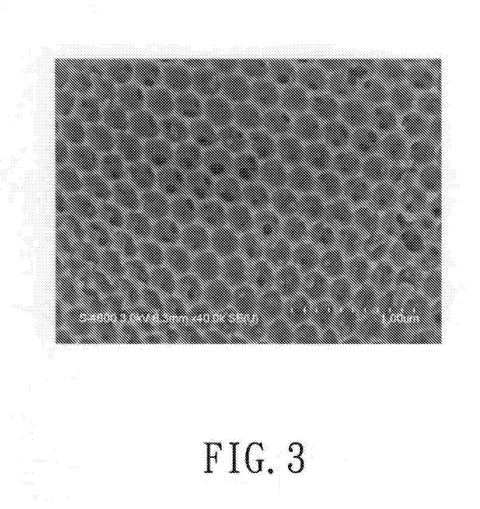

FIG. 3 is a scanning electron microscope image of the inverse-type 3D photonic crystal of Example 40, showing a plurality of holes formed by removing the particulate material.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

What is claimed is:

1. A method for making a 3D photonic crystal, comprising:
(a) preparing a liquid mixture including a solvent component, a particulate material suspended in the solvent component, and a filler suspended or dissolved ih the solvent component, with the proviso that, when the filler is suspended in the solvent component, the filler has an average size smaller than an average size of the particulate material;
(b) allowing a 3D photonic structure to grow from the liquid mixture; and
(c) removing liquid from the 3D photonic structure.

2. The method of claim 1, wherein the average size of the particulate material ranges from 0.1 μm to 10 μm.

3. The method of claim 1, wherein the average size of the filler is smaller than 1/10 of that of the particulate material.

4. The method of claim 1, wherein the particulate material is made from a material selected from the group consisting of organic polymer, inorganic compound, metal, and combinations thereof.

5. The method of claim 4, wherein the organic polymer is made from a material selected from the group consisting of polymers of polystyrene series, polymethyl methacrylate series, poly(maleic acid) series, polylactic acid series, polyamino acid series, and combinations thereof.

6. The method of claim 4, wherein the inorganic compound is selected from the group consisting of Ag₂O, CuO, ZnO, CdO, NiO, PdO, CoO, MgO, SiO₂, SnO₂, TiO₂, ZrO₂, HfO₂, ThO₂, CeO₂, CoO₂, MnO₂, IrO₂, VO₂, WO₃, MoO₃, Al₂O₃, Y₂O₃, Yb₂O₃, Dy₂O₃, B₂O₃, Cr₂O₃, Fe₂O₃, Fe₃O₄, Nb₂O₅, ZnS, ZnSe, ZnTe, CdS, CdSe, CdTe, FeS, FeSe, FeTe, CoS, CoSe, CoTe, NiS, NiSe, NiTe, PbS, PbSe, PbTe, MnS, MnSe, MnTe, SnS, SnSe, SnTe, MoS₂, MoSe₂, MoTe₂, WSe₂, WTe₂, Cu₂S, Cu₂Se, Cu₂Te, Bi₂S₃, Bi₂Se₃, Bi₂Te₂, SiC, TiC, ZrC, WC, NbC, TaC, Mo₂C, BN, AlN, TiN, ZrN, VN, NbN, TaN, Si₃N₄, Zr₃N₄, and combinations thereof.

7. The method of claim 4, wherein the metal is selected from the group consisting of Au, Ag, Cu, Fe, Co, Ni, Pd, Pt, Al, Si, Ti, Zr, V, Nb, Mo, W, Mn, and combinations thereof.

8. The method of claim 1, wherein the filler is made of a material selected from the group consisting of an inorganic salt, inorganic oxide, metal, inorganic alkoxide, and combinations thereof.

9. The method of claim 8, wherein the inorganic salt is selected from the group consisting of group IIIA elements, group IVA elements, group VA elements, group VIA elements, group VIIA elements, and combinations thereof.

10. The method of claim 8, wherein the inorganic oxide is selected from the group consisting of Ag₂O, CuO, ZnO, CdO, NiO, PdO, CoO, MgO, SiO₂, SnO₂, TiO₂, ZrO₂, HfO₂, ThO₂, CeO₂, CoO₂, MnO₂, IrO₂, VO₂, WO₃, MoO₃, Al₂O₃, Y₂O₃, Yb₂O₃, Dy₂O₃, B₂O₃, Cr₂O₃, Fe₂O₃, Fe₃O₄, V₂O₅, Nb₂O₅, and combinations thereof.

11. The method of claim 8, wherein the metal is selected from the group consisting of Au, Ag, Cu, Fe, Co, Ni, Pd, Pt, Al, Si, Ti, Zr, V, Nb, Mo, W, Mn, and combinations thereof.

12. The method of claim 8, wherein the inorganic alkoxide is selected from the group consisting of alkoxysilane, aluminum alkoxide, titanium alkoxide, zirconium alkoxide, and combinations thereof.

13. The method of claim 1, wherein the step (b) is conducted by gravity sedimentation, centrifugal sedimentation, electrical sedimentation, magnetic sedimentation, vacuum filtration, pressure filtration, centrifugal filtration, or combinations thereof.

14. The method of claim 1, wherein the step (c) is conducted by natural drying, vacuum drying, oven drying, microwave drying, infrared drying, or combinations thereof.

15. The method of claim 1, further comprising:
(d) removing the particulate material from the 3D photonic structure after the step (c);
wherein the particulate material and the filler are made of different materials.

16. The method of claim 15, wherein, in the step (d), the particulate material is removed by a calcining process.

17. The method of claim 15, wherein, in the step (d), the particulate material is removed by dissolving the particulate material in a solvent.
